(19) United States
(12) Patent Application Publication
(10) Pub. No.: US 2018/0336086 A1
(43) Pub. Date: Nov. 22, 2018

(54) SYSTEM STATE INFORMATION MONITORING

(71) Applicant: HEWLETT PACKARD ENTERPRISE DEVELOPMENT LP, Houston, TX (US)

(72) Inventors: Thomas L. Vaden, Fort Collins, CO (US); Micah Parrish, Fort Collins, CO (US); Andrew Brown, Houston, TX (US)

(21) Appl. No.: 15/777,002

(22) PCT Filed: Jan. 29, 2016
(86) PCT No.: PCT/US2016/015792

§ 371 Date: May 17, 2018

(51) Int. Cl. G06F 11/07

(52) U.S. Cl. CPC G06F 11/0778; G06F 11/079; G06F 11/0751

(57) ABSTRACT

In one example, a system includes an out-of-band monitoring engine to determine system state information by monitoring a system state of the system and a dump engine to provide the system state information to a computing device for analysis. The out-of-band monitoring engine can determine system state information in response to a failure of an operating system during start-up, determine system state information in response to a catastrophic error occurring to an operating system, and determine system state information of a functioning operating system.

### BACKGROUND

Operating systems can be monitored using an in-band monitoring system to determine system state information. The in-band monitoring system uses applications that are operating on the system that is being monitored to obtain system state information. When an operating system fails, the system state information may not be available when using an in-band monitoring system. When the system state information is not available, a dump may not be performed. Therefore, the cause of the failure will not be known and other problems with the computing system may occur due to the system state information being unavailable.

### BRIEF DESCRIPTION OF THE DRAWINGS

FIG. 1 illustrates a diagram of an example system for system state information monitoring consistent with the present disclosure.

FIG. 2 illustrates a diagram of an example computing device for system state information monitoring consistent with the present disclosure.

FIG. 3 illustrates a diagram of an example system for system state information monitoring consistent with the present disclosure.

FIG. 4 illustrates a flow chart of an example method for system state information monitoring consistent with the present disclosure.

### DETAILED DESCRIPTION

A set of examples for system state monitoring are described herein. In one example, a system includes an out-of-band monitoring engine to determine system state information by monitoring a system state of the system and a dump engine to provide the system state information for analysis.

In some examples, a dump of system state information can be enabled by monitoring the system state information using an out-of-band monitoring engine (e.g., out-of-band embedded controller). An application running on the out-of-band monitoring engine can monitor and extract system state information of the system to dump the system state information. The system state information can be monitored and extracted during start-up of an operation system and/or while the operating system is initialized and functional. The system state information that is extracted by the out-of-band monitoring engine can be beneficial when there is not an operative in-band crash dump. There may not be an operative in-band crash dump available if the operating system crashes during early stages of start-up. An in-band crash dump may not be available when a catastrophic error occurs. A catastrophic error can include an error where the system state information may not be available as a result of the error. A catastrophic error can occur after the operating system has begun to boot, but before the operating system as initialized enough the capture system state information and/or after the operating system has initialized. Also, the monitoring the system state information can be beneficial while the operating system is initialized and functional to provide verification and analysis of the system state information for a functional operation system.

The examples of system state monitoring described herein can monitor and extract system state information using an out-of-band monitoring engine. An out-of-band monitoring engine can include system access window base address (SAWBASE) hardware, for example. SAWBASE hardware can extract system state information from a computing device. In some examples, an operating system memory topology can be exported to the out-of-band monitoring engine and then be used by the SAWBASE hardware to extract system state information. Also, an application running on a computing device external to the out-of-band monitoring engine can connect with the out-of-band monitoring engine to use the SAWBASE hardware to monitor and extract the system state information.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a set of additional examples of the present disclosure. In addition, the proportion and the relative scale of the elements provided in the figures are intended to illustrate the examples of the present disclosure, and should not be taken in a limiting sense.

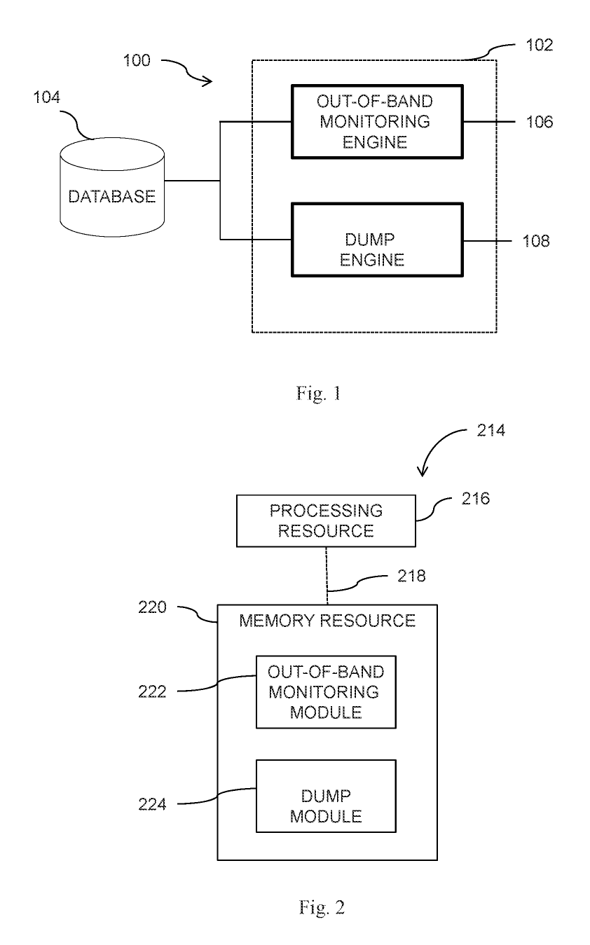

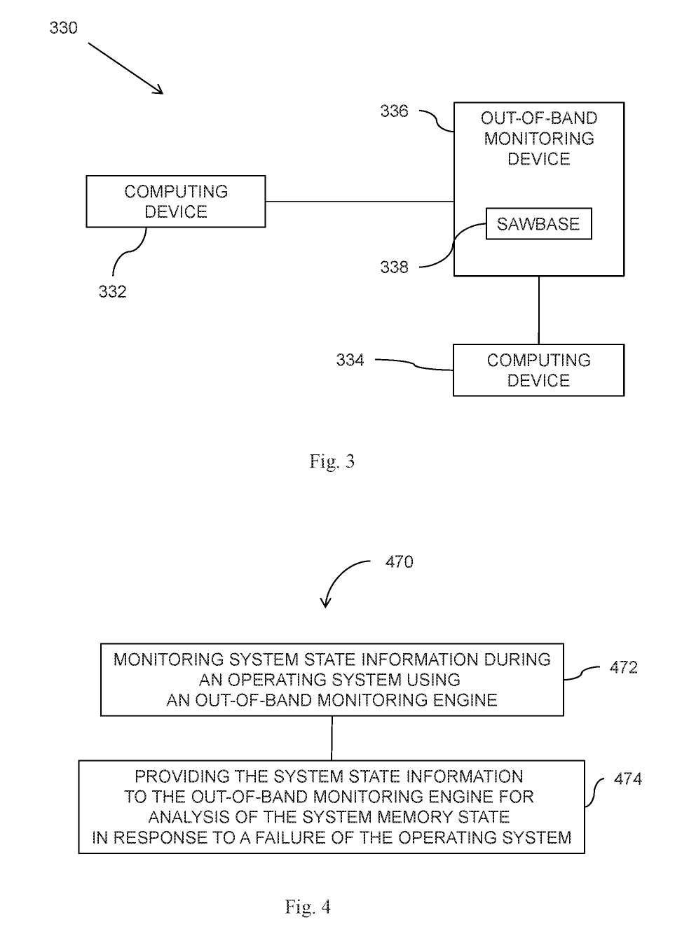

FIGS. 1 and 2 respectively illustrate an example system 100 and an example computing device 214 consistent with the present disclosure. FIG. 1 illustrates a diagram of an example system 100 for system state information monitoring consistent with the present disclosure. The system 100 can include a database 104, a system state information monitoring system 102, or a set of engines (e.g., out-of-band engine 106 and dump engine 108). The system state information monitoring system 102 can be in communication with the database 104 via a communication link, and can include the set of engines (e.g., out-of-band monitoring engine 106 and dump engine 108). The system state information monitoring system 102 can include additional or fewer engines than are illustrated to perform the various functions as will be described in further detail in connection with FIGS. 3-4.

The set of engines (e.g., out-of-band engine 106 and dump engine 108) can include a combination of hardware and programming, but at least hardware, that can perform functions described herein (e.g., determine system state information and provide the system state information to a computing device, etc.) stored in a memory resource (e.g., computer readable medium, machine readable medium, etc.) as well as hard-wired program (e.g., logic).

The out-of-band monitoring engine 106 and dump engine 108 can include hardware or a combination of hardware and programming, but at least hardware, to monitoring system state information. In some examples, out-of-band monitoring engine 106 can determine system state information of a system and dump engine 108 can provide the system state information to a memory device for analysis.

In some examples, the out-of-band monitoring engine 106 can determine system state information before an operating system is operational and/or after the operating system is initialized. For example, the out-of-band monitoring engine 106 can utilize SAWBASE hardware and the operating system memory topology to extract the system state information. In some examples, the dump engine 108 can provide the system state information for analysis in response to a failure of the operating system. The failure of the operating system can be during start-up of the operation system and/or a catastrophic failure after the operating system has initialized. The dump engine 108 can provide the system state information to an out-of-band monitoring device or another computing device for analysis. The dump engine 106 can output (e.g., send via a network) the system state information to a computing device for analysis. The system state information can include a copy of a computing device's memory when the operating system failed and/or include copy of the computing device's memory when the operating is functional. An out-of-band monitoring device and/or another computing device can analyze the system state information to diagnose and cure the problem that caused the operation system to fail and/or to provide analysis of a functioning operating system.

FIG. 2 illustrates a diagram of an example computing device 214 consistent with the present disclosure. The computing device 214 can utilize software, hardware, firmware, or logic to perform functions described herein.

The computing device 214 can be any combination of hardware and program instructions configured to share information. The hardware, for example, can include a processing resource 216 or a memory resource 220 (e.g., computer-readable medium (CRM), machine readable medium (MRM), database, etc.). A processing resource 216, as used herein, can include any set of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a function (e.g., determine system state information and provide the system state information to a computing device for analysis, etc.).

The memory resource 220 can be in communication with a processing resource 216. A memory resource 220, as used herein, can include any set of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a communication link 218 can include an electronic bus internal to a machine (e.g., a computing device) where the memory resource 220 is one of volatile, non-volatile, fixed, or removable storage medium in communication with the processing resource 216 via the electronic bus.

A set of modules (e.g., out-of-band monitoring module 222 and dump module 224) can include CRI that when executed by the processing resource 216 can perform functions. The set of modules (e.g., out-of-band monitoring module 222 and dump module 224) can be sub-modules of other modules. For example, the out-of-band monitoring module 222, dump module 224 and/or another module can be sub-modules or contained within the same computing device. In another example, the set of modules (e.g., out-of-band monitoring module 222 and dump module 224) can comprise individual modules at separate and distinct locations (e.g., CRM, etc.).

As used herein, a set of modules (e.g., out-of-band monitoring module 222 and dump module 224) can include instructions that when executed by the processing resource 216 can function as a corresponding engine as described herein. For example, the out-of-band monitoring module 222 can include instructions that when executed by the processing resource 216 can function as the out-of-band monitoring engine 106.

FIG. 3 illustrates a diagram of an example system 330 for system state information monitoring consistent with the present disclosure. In some examples, the system 330 can represent a computing system where a set of computing devices 332, 334 are communicating with an out-of-band monitoring device 336. In some examples, the number of computing devices 332, 334 can be a participant device, a server device, or a collection of server devices, or a combination of the participant device and the server device. The computing device 332 can be monitored by the out-of-band monitoring device 336 to determine system state information for the computing device, The system state information can include a copy of the computing device's memory, which can include system status data and/or host data. The system state information can also include CPU registers, vendor MSR, PCI configuration space, and/or PCI registers, among other information. The system state information can also include a copy of the crash dump crash kernel for computing device 332.

The computing device 332 can be monitored by the out-of-band monitoring device 336 during start-up of the operation system of the computing device 332 and/or after the operating system of the computing device 332 has initialized and is functional. The system state information can be obtained during and/or after a successful start-up of the operation system or during a failed start-up of the operation system. In the case of a failure of the operating system during start-up the system state information that is obtained by the out-of-band monitoring device 336 can be used to crash dump that computing device's memory. The system state information obtained by the out-of-band monitoring device 336 can be useful when there is not an operative in-band crash dump. There may not be an operative in-band crash dump available if the operating system crashes during early stages of start-up. An in-band crash dump may not be available when a catastrophic error happens after the operating system has begun to boot, but before the operating system has initialized enough the capture system state information. For example, unified extensible firmware interface (UEFI) systems are susceptible to not having an in-band crash dump available because they have a separate boot services environment that is unavailable when the operating system initialization leaves the booting phase to execute the early phases of construction of the running operating system environment. Also, a running operating system that has fully initialized could become incapacitated to the point of not being able to successfully accomplish an in-band crash dump when a catastrophic error occurs.

In some examples, out-of-band monitoring device 336 can include access window base address (SAWBASE) hardware 338. SAWBASE hardware 338 can be used to extract system state information from computing device 332. In some examples, an operating system memory topology can be exported to the out-of-band monitoring device 336 and then used by the SAWBASE hardware 338 to extract system state information from computing device 332.

In some examples, computing device 334 can be coupled via a network to the out-of-band monitoring device 336. The computing device 334 can run an application that connects with the out-of-band monitoring engine to use the SAWBASE hardware to monitor and extract the system state information from computing device 332. The system state information can then be stored on computing device 334.

The system state information extracted by the out-of-band monitoring device 336 can be analyzed by the out-of-band monitoring device 336 and/or another computing device, such as computing device 334. The system state information can be analyzed in real time (e.g., as the operating system is crashing) or can be stored in the out-of-band monitoring device 336 and/or another computing device, such as computing device 334, for analysis at a later time. The system state information can be analyzed in real time to determine a cause of a failure and provide a solution for the failure so the operating system can properly start-up.

FIG. 4 illustrates a flow chart of an example method 470 for system state information monitoring consistent with the present disclosure. The method 470 can be executed by a system and/or computing device as described herein. In some examples, the method 470 can be executed by a computing device (e.g., computer, controller, microcontroller, etc.) that monitoring system state information of another computing device. In some examples, the computing device that is monitoring the system state information can execute an application on the computing to monitor the system state information.

At 472, the method 470 can include monitoring system state information of an operating system using an out-of-band monitoring engine. In some examples, the method 470 can include monitoring instruction pointers and registers to obtain system status data and/or host memory data.

At 474, the method 470 can include providing the system state information to the out-of-band monitoring engine for analysis of the system memory state in response to a failure of the operating system. Also, the method 470 includes analyzing the system state information during the operating system start-up and/or after the operating system has initialized.

As used herein, “logic” is an alternative or additional processing resource to perform a particular action or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a set of” something can refer to one or more such things. For example, “a set of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A system, comprising:
an out-of-band monitoring engine to determine system state information by monitoring a system state of the system; and
a dump engine to provide the system state information to a computing device for analysis.

2. The system of claim 1, wherein the out-of-band monitoring engine is to determine the system state information in response to a failure of an operating system during start-up.

3. The system of claim 1, wherein the out-of-band monitoring engine is to determine the system state information in response to a catastrophic error occurring to an operating system.

4. The system of claim 1, wherein the out-of-band monitoring engine is to determine the system state information of a functioning operating system.

5. The system of claim 1, wherein the system state information includes system status data and host memory data.

6. A method, comprising:
monitoring a system state of a system using an out-of-band monitoring engine to determine system state information; and
providing the system state information to the out-of-band monitoring engine for analysis of the system state in response to a failure of the operating system.

7. The method of claim 6, wherein monitoring the system state information includes monitoring instruction pointers and registers to obtain system state information.

8. The method of claim 6, wherein monitoring the system state information includes monitoring system state information to obtain host memory data.

9. The method of claim 6, wherein providing the system state information includes storing the system state information for analysis at a later time.

10. The method of claim 6, wherein monitoring system state information includes using system access window base address (SAWBASE) hardware to access the system state information.

11. A non-transitory machine-readable medium comprising instructions executable by a processor to cause the processor to:
determine system state information of a system using an out-of-band monitoring engine; and
output the system state information for analysis of he system.

12. The non-transitory machine-readable medium of claim 11, wherein the instructions executable by the processor to cause the processor to determine the system state information that includes a crash dump crash kernel.

13. The non-transitory machine-readable medium of claim 11, wherein the instructions executable by the processor to cause the processor to determine the system state information during a successful start-up of the operating system.

14. The non-transitory machine-readable medium of claim 11, wherein the instructions executable by the processor to cause the processor to determine the system state information are from an application external to the out-of-band monitoring engine.

15. The non-transitory machine-readable medium of claim 11, wherein the instructions executable by the processor to cause the processor to determine the system state information are from an application running on the out-of-band monitoring engine.
